(19) United States
(12) Patent Application Publication
(10) Pub. No.: US 2015/0188344 A1
(43) Pub. Date: Jul. 2, 2015

(54) CHARGING AND DISCHARGING CONTROL SYSTEM AND METHOD FOR BATTERY

(71) Applicant: HON HAI PRECISION INDUSTRY CO., LTD., New Taipei (TW)

(72) Inventors: HUNG-YI WANG, New Taipei (TW); PO-ERH SHIH, New Taipei (TW)

(21) Appl. No.: 14/556,394

(22) Filed: Dec. 1, 2014

(30) Foreign Application Priority Data
Dec. 27, 2013 (TW) 102148819

(51) Int. Cl. H02J 7/00

(52) U.S. Cl. CPC H02J 7/0052; H02J 7/007; H02J 2007/0059

(57) ABSTRACT

A charging and discharging control system for a battery is disclosed, and the battery is configured to charge or discharge for a peripheral device. The charging and discharging control system includes a voltage converting circuit, an embedded controller, a current detection circuit. The voltage converting circuit is electrically connected the battery with the peripheral device, and the battery charges the peripheral. The embedded controller is electrically coupled to the voltage converting circuit. The current detection circuit electrically coupled to the voltage converting circuit. The current detection circuit is configured to detect a current value between the battery and the peripheral device and send a power-off signal when the current value is equal to zero. The embedded controller is configured to send a power-off notification upon detecting the power-off signal, and the voltage converting circuit disconnects the battery and the peripheral device upon receiving the power-off notification.

### CROSS-REFERENCE TO RELATED APPLICATIONS

This application claims priority to Taiwanese Patent Application No. 102148819 filed on Dec. 27, 2013 in the Taiwan Intellectual Property Office, the contents of which are hereby incorporated by reference.

### FIELD

The present disclosure relates to charging and discharging control systems and methods, and more particularly to a charging and discharging control system and method for a battery.

### BACKGROUND

Notebook computers can include a plurality of input and output interfaces for connecting to different peripheral devices, such as phones, portable power sources, and so on. A battery in the notebook computer always typically supplies the plurality of input and output interfaces whether or not the peripheral devices are plugged in.

### BRIEF DESCRIPTION OF THE DRAWINGS

Implementations of the present technology will now be described, by way of example only, with reference to the attached figures.

FIG. 1 is a block diagram of one embodiment of a charging and discharging control system.

FIG. 2 is a circuit diagram of the charging and discharging control system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The “coupled” is defined as connected, whether directly or indirectly through intervening components, and is not necessarily limited to physical connections. The connection can be such that the objects are permanently connected or releasably connected.

The term “comprising,” when utilized, means “including, but not necessarily limited to”; it specifically indicates open-ended inclusion or membership in the so-described combination, group, series and the like.

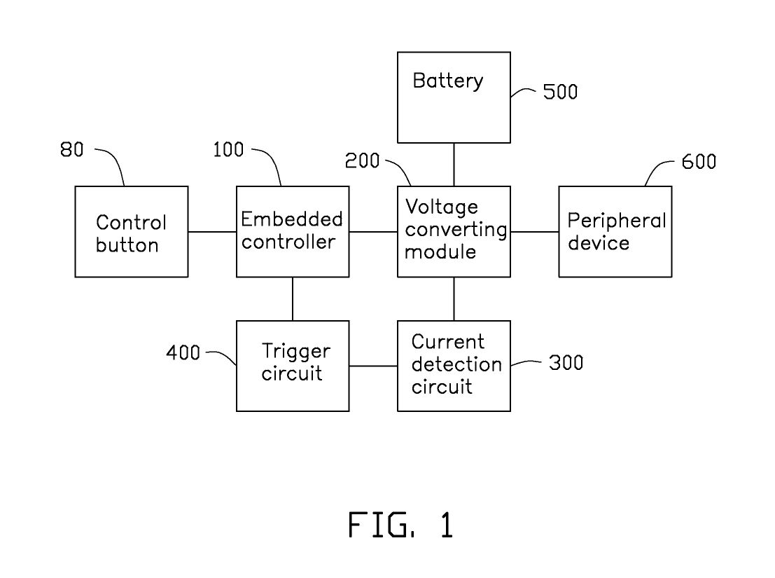

FIG. 1 illustrates one embodiment of a charging and discharging control system for a battery 500. The battery 500 can charge or discharge for a peripheral device 600, and the peripheral device 600 may be a phone, a portable power source, and so on. The charging and discharging control system can include an embedded controller 100, a voltage converting circuit 200, a current detection circuit 300, and a trigger circuit 400. The battery 500, the embedded controller 100, the voltage converting circuit 200, the current detection circuit 300, and the trigger circuit 400 can be integrated in a computer.

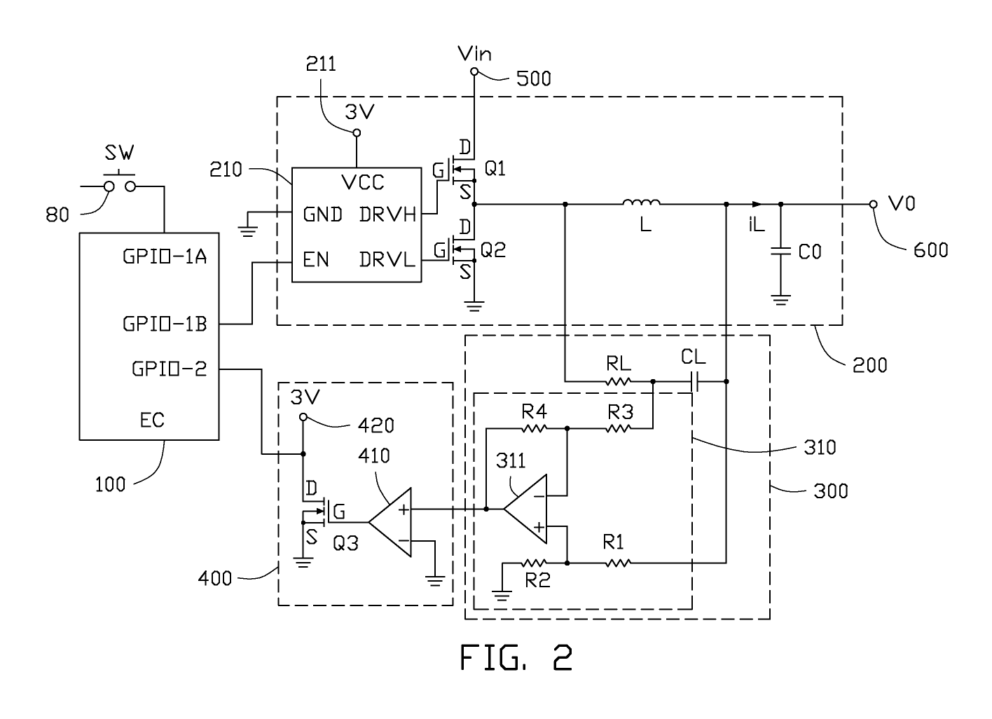

FIG. 2 illustrates that the embedded controller 100 can be electrically coupled to a control button 80 and the voltage converting circuit 200. The voltage converting circuit 200 can be electrically coupled to the peripheral device 600, the current detection circuit 300, and the battery 500. The trigger circuit 400 can be electrically coupled to the embedded controller 100 and the current detection circuit 300.

The embedded controller 100 can include a first general purpose input-output port GPIO_1A, a second general input-output port GPIO_1B, and a third general input-output port GPIO_2. The voltage converting circuit 200 can include a synchronous buck controller 210, a first transistor Q1, a second transistor Q2, an inductor L, and a first capacitor C0. The synchronous buck controller 210 can include an enable port EN, a first driven signal output port DRVH, a second driven signal output port DRVL, and a voltage input port VCC.

The first general purpose input-output port GPIO_1A can be electrically coupled to the control button 80. The second general purpose input-output port GPIO_1B can be electrically coupled to the enable port EN of the synchronous buck controller 210. A ground GND of the synchronous buck controller 210 can be grounded. The voltage input port VCC can be electrically coupled to a first work voltage 211, and the first work voltage 211 can be 3V. The first driven signal output port DRVH can be electrically coupled to a grid electrode of the first transistor Q1. A drain electrode of the first transistor Q1 can be coupled to the battery 500, and a source electrode of the first transistor Q1 can be electrically coupled to a drain electrode of the second transistor Q2 and a first end of the inductor L. The second driven signal output pot DRVL can be electrically coupled to a grid electrode of the second transistor Q2. A source electrode of the second resistor Q2 can be grounded. A second end of the inductor L can be electrically coupled to a positive electrode of the first capacitor C0 and the peripheral device 600. A negative electrode of the first capacitor C0 can be grounded.

The current detection circuit 300 can include an amplification circuit 310, a load resistor R_{L} and a second capacitor CL. The load resistor RL and the second capacitor CL are in series, and the load resistor RL and the second capacitor CL are in parallel with the inductor L. The amplification circuit 310 can include a first comparator 311, a first resistor R1, a second resistor R2, a third resistor R3, and a fourth resistor R4. A first end of the first resistor R1 can be electrically coupled to the first capacitor C0 and the second capacitor CL, and a second end of the first resistor R1 can be electrically coupled to a positive electrode of the first comparator 311 and a first end of the second resistor R2. A second end of the second resistor R2 can be grounded. A first end of the third resistor R3 can be electrically coupled to the load resistor RL and the second capacitor CL, and a second end of the third resistor R3 can be electrically coupled to a negative electrode of the first comparator 311 and a first end of the fourth resistor R4. A second end of the fourth resistor R4 can be electrically coupled to the trigger circuit 400 and an output end of the first comparator 311.

The trigger circuit 400 can include a second comparator 410 and a third transistor Q3. A positive electrode of the second comparator 410 can be electrically coupled to the output of the first comparator 311, and a negative electrode of the second comparator 410 can be grounded. An output end of the second comparator 311 can be electrically coupled to a grid electrode of the third transistor Q3. A source electrode of the third transistor Q3 is grounded, and a drain electrode of the third transistor Q3 can be electrically coupled to the second general purpose input-output port GPIO_1B and a second work voltage 420, and the second work voltage 420 may be 3V.

In use, the control button 80 is pressed to generate a charging control signal. The first general purpose input-output port GPIO_1A of the embedded controller 100 can detect the charging control signal and send a charging notification to the synchronous buck controller 210. The first driven signal output port DRVH of the synchronous buck controller 210 can send a high level (representative of 1), to switch on the first transistor Q1. Simultaneously, the second driven signal output port DRVL of the synchronous buck controller 210 can send a low level (representative of 0), to switch on the second transistor Q2. Thus, the battery 500 can charge for the peripheral device 600.

When the battery level of the peripheral device 600 is up to 100%, the current value passing through the inductor L is equal to zero. A potential of the positive electrode of the first comparator 311 is greater than that of the negative electrode of the first comparator 311, so that the output end of the comparator 311 outputs a high level (representative of 1) to switch on the third transistor Q3. A potential of the third general purpose input-output GPIO_2 is pulled down to a low level (representative of 0). The embedded controller 100 can send a power-off signal to the synchronous buck controller 210. The first driven signal output port DRVH can send a low level, to switch off the first transistor Q1. Simultaneously, the second driven signal output port DRVL can send a high level, to switch on the second transistor Q2.

The embodiments shown and described above are only examples. Many details are often found in the art such as the other features of a charging and discharging control system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A charging and discharging control system for a battery, the charging and discharging control system comprising:
a voltage converting circuit electrically connecting a battery to a peripheral device, and the battery charging the peripheral device;
an embedded controller electrically coupled to the voltage converting circuit; and
a current detection circuit electrically coupled to the voltage converting circuit;
wherein the current detection circuit is configured to detect a current value between the battery and the peripheral device and send a power-off signal when the current value is equal to zero, the embedded controller is configured to send a power-off notification upon detecting the power-off signal, and the voltage converting circuit disconnects the battery and the peripheral device upon receiving the power-off notification.

2. The charging and discharging control system of claim 1, further comprising a control button coupled to the embedded controller, wherein the control button is configured to generate a charging control signal, the embedded controller is configured to send a charging notification upon detecting the charging control signal, and the voltage converting circuit connects the battery with the peripheral device upon receiving the charging notification.

3. The charging and discharging control system of claim 2, further comprising a trigger circuit electrically coupled to the embedded controller and the current detection circuit, wherein the current detection circuit is configured to send the power-off signal to the trigger circuit when the current value is equal to zero, the trigger circuit is configured to generate a low level signal upon receiving the power-off signal, and the embedded controller is configured to send the power-off notification to the voltage converting circuit upon detecting the low level signal.

4. The charging and discharging control system of claim 3, wherein the voltage converting circuit comprises a synchronous buck controller, a first transistor, and a second transistor; the synchronous buck controller comprises a first driven signal output port and a second driven signal output port, the first driven signal output port is electrically coupled to a gate electrode of the first transistor, and the second driven signal output port is electrically coupled to the a gate electrode of the second transistor.

5. The charging and discharging control system of claim 4, wherein a drain electrode of the first transistor is electrically coupled to the battery, and a source electrode of the first transistor is electrically coupled to a drain electrode of the second transistor, and a source electrode of the second transistor is electrically grounded.

6. The charging and discharging control system of claim 5, wherein the voltage converting circuit further comprises an inductor and a first capacitor, a first end of the inductor is electrically coupled to the source electrode of the first transistor and the drain electrode of the second transistor, and a second end of the inductor is electrically coupled to a positive electrode of the first capacitor and the peripheral device, and a negative electrode of the first capacitor is grounded.

7. The charging and discharging control system of claim 6, wherein the current detection circuit comprises a load resistor and a second capacitor, the load resistor and the second capacitor are in series, and the load resistor and the second capacitor are in parallel with the inductor.

8. The charging and discharging control system of claim 7, wherein the current detection circuit further comprises an amplification circuit, the amplification circuit comprises a first resistor, a second resistor, a third resistor, a fourth resistor, and a first comparator; a first end of the first resistor is electrically coupled to the first capacitor and the second capacitor, and a second end of the first resistor is electrically coupled to a first end of the second resistor and a positive electrode of the comparator, a second end of second resistor is electrically grounded; a first end of the third resistor is electrically coupled to the load resistor and the second capacitor, and a second end of the third resistor is electrically coupled to a negative electrode of the comparator and a first end of the fourth resistor; and a second end of the fourth resistor is electrically coupled to the trigger circuit.

9. The charging and discharging control system of claim 4, wherein the trigger circuit comprises a second comparator and a third transistor, a positive electrode of the second comparator is electrically coupled to an output end of the current detection circuit, and the negative electrode of the second comparator is grounded, an output end of the second comparator is electrically coupled to a grid electrode of the third transistor, a drain electrode of the third transistor is electrically coupled to the embedded controller and a second wok voltage, and a source of third transistor is grounded.

10. The charging and discharging control system of claim 9, wherein the embedded controller comprises a first general purpose input-output port, a second general purpose input-output port, the first general purpose input-output port is electrically coupled to the control button, the second general purpose input-output port is electrically coupled to an enable end of the synchronous buck controller, the third general purpose input-output port is electrically coupled to the second work voltage.

11. A charging and discharging control system for a battery, the battery configured to charge or discharge for a peripheral device, the charging and discharging control system comprising:
a voltage converting circuit electrically connecting the battery with the peripheral device;
an embedded controller electrically coupled to voltage converting circuit;
a current detection circuit electrically coupled to the voltage converting circuit; and
a trigger circuit electrically coupled to the embedded controller and the current detection circuit;
Wherein the current detection circuit is configured to detect a current value between the battery and the peripheral device and send a power-off signal when the current value is equal to zero, the trigger circuit is configured to send a low level signal upon receiving the power-off signal, the embedded controller is configured to send a power-off notification upon detecting the low level signal, and the voltage converting circuit disconnects the battery and the peripheral device upon receiving the power-off notification.

12. The charging and discharging control system of claim 11, further comprising a control button coupled to the embedded controller, wherein the control button is configured to generate a charging control signal, the embedded controller is configured to send a charging notification upon detecting the charging control signal, and the voltage converting circuit connects the battery with the peripheral device upon receiving the charging notification.

13. The charging and discharging control system of claim 12, wherein the current detection circuit is configured to send the power-off signal to the trigger circuit when the current value is equal to zero, the trigger circuit is configured to generate a low level signal upon receiving the power-off signal, and the embedded controller is configured to send the power-off notification to the voltage converting circuit upon detecting the low level signal.

14. The charging and discharging control system of claim 13, wherein the voltage converting circuit comprises a synchronous buck controller, a first transistor, and a second transistor; the synchronous buck controller comprises a first driven signal output port and a second driven signal output port, the first driven signal output port is electrically coupled to a gate electrode of the first transistor, and the second driven signal output port is electrically coupled to the a gate electrode of the second transistor.

15. The charging and discharging control system of claim 14, wherein a drain electrode of the first transistor is electrically coupled to the battery, and a source electrode of the first transistor is electrically coupled to a drain electrode of the second transistor, and a source electrode of the second transistor is electrically grounded.

16. The charging and discharging control system of claim 15, wherein the voltage converting circuit further comprises an inductor and a first capacitor, a first end of the inductor is electrically coupled to the source electrode of the first transistor and the drain electrode of the second transistor, and a second end of the inductor is electrically coupled to a positive electrode of the first capacitor and the peripheral device, and a negative electrode of the first capacitor is grounded.

17. The charging and discharging control system of claim 16, wherein the current detection circuit comprises a load resistor and a second capacitor, the load resistor and the second capacitor are in series, and the load resistor and the second capacitor are in parallel with the inductor.

18. The charging and discharging control system of claim 17, wherein the current detection circuit further comprises an amplification circuit, the amplification circuit comprises a first resistor, a second resistor, a third resistor, a fourth resistor, and a first comparator; a first end of the first resistor is electrically coupled to the first capacitor and the second capacitor, and a second end of the first resistor is electrically coupled to a first end of the second resistor and a positive electrode of the comparator, a second end of second resistor is electrically grounded; a first end of the third resistor is electrically coupled to the load resistor and the second capacitor, and a second end of the third resistor is electrically coupled to a negative electrode of the comparator and a first end of the fourth resistor; and a second end of the fourth resistor is electrically coupled to the trigger circuit.

19. The charging and discharging control system of claim 14, wherein the trigger circuit comprises a second comparator and a third transistor, a positive electrode of the second comparator is electrically coupled to an output end of the current detection circuit, and the negative electrode of the second comparator is grounded, an output end of the second comparator is electrically coupled to a grid electrode of the third transistor, a drain electrode of the third transistor is electrically coupled to the embedded controller and a second wok voltage, and a source of third transistor is grounded.

20. The charging and discharging control system of claim 19, wherein the embedded controller comprises a first general purpose input-output port, a second general purpose input-output port, the first general purpose input-output port is electrically coupled to the control button, the second general purpose input-output port is electrically coupled to an enable end of the synchronous buck controller, the third general purpose input-output port is electrically coupled to the second work voltage.
